(19) United States
(12) Patent Application Publication
(10) Pub. No.: US 2011/0304078 A1
(43) Pub. Date: Dec. 15, 2011

(54) METHODS FOR REMOVING BYPRODUCTS FROM LOAD LOCK CHAMBERS

(75) Inventors: JARED AHMAD LEE, Santa Clara, CA (US); BENJAMIN SCHWARZ, San Jose, CA (US); XIAOLIANG ZHUANG, Sunnyvale, CA (US); EU JIN LIM, Sunnyvale, CA (US); ADUATO DIAZ, JR., Saratoga, CA (US); SCOTT M. WILLIAMS, Sunnyvale, CA (US); ANDREW NGUYEN, San Jose, CA (US); JAMES P. CRUSE, Santa Cruz, CA (US)

(73) Assignee: APPLIED MATERIALS, INC., Santa Clara, CA (US)

(21) Appl. No.: 13/014,800

(22) Filed: Jan. 27, 2011

Related U.S. Application Data
(60) Provisional application No. 61/354,520, filed on Jun. 14, 2010.

(51) Int. Cl. B29C 71/00

(52) U.S. Cl. 264/344

(57) ABSTRACT

Methods for removing process byproducts from a load lock chamber are provided herein. In some embodiments, a method for removing process byproducts from a load lock chamber may include: performing a process on a substrate disposed within a process chamber; transferring the substrate from the process chamber to a load lock chamber; and providing an inert gas to the load lock chamber via at least one gas line while transferring the substrate from the process chamber to the load lock chamber to remove process byproducts from the load lock chamber.

### CROSS-REFERENCE TO RELATED APPLICATIONS

This application claims benefit of U.S. provisional patent application Ser. No. 61/354,520, filed Jun. 14, 2010, which is herein incorporated by reference.

### FIELD

Embodiments of the present invention generally relate to a substrate processing systems.

### BACKGROUND

Some substrate processing systems may include a load lock chamber configured to transfer substrates into and out of the processing system. Substrates are removed from the load lock chamber via a transfer robot and transported to one or more process chambers within the system. Once processed, the substrates are returned from the process chambers to the load lock chamber for removal from the system. However, after certain processes are performed, the processed substrates may outgas a variety of process-dependent gases, for example, bromine, ozone gas or the like. In addition, the outgassing of the process-dependent gases may be further facilitated in load lock chambers where additional processes, for example abatement processes, are performed. The inventors have discovered that such gases may condense on surfaces and within gas lines of the load lock chamber, causing corrosion, contamination and particle formation.

Accordingly, the inventors have provided improved methods for removing processing byproducts from load lock chambers.

### SUMMARY

Methods for removing process byproducts from a load lock chamber are provided herein. In some embodiments, a method for removing process byproducts from a load lock chamber may include: performing a process on a substrate disposed within a process chamber; transferring the substrate from the process chamber to a load lock chamber; and providing an inert gas to the load lock chamber via at least one gas line while transferring the substrate from the process chamber to the load lock chamber to remove process byproducts from the load lock chamber.

In some embodiments, a method for removing process byproducts from a load lock chamber may include performing a process on a substrate disposed within a process chamber; transferring the substrate from the process chamber to a load lock chamber; and providing an inert gas to the load lock chamber via a dedicated purge gas line while transferring the substrate from the process chamber to the load lock chamber.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 depicts a substrate processing system suitable for processing substrates in accordance with some embodiments of present invention.

FIG. 2 depicts of a load lock chamber suitable for processing substrates in accordance with some embodiments of present invention.

FIG. 3 depicts a gas source suitable for processing substrates in accordance with some embodiments of present invention.

FIG. 4 depicts a flow diagram of a method for removing byproducts in a load lock chamber in accordance with some embodiments of present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Methods for removing process byproducts from a load lock chamber are disclosed herein. The inventive method advantageously prevents corrosion and contamination of substrate processing systems by preventing process byproducts from condensing within gas lines and upon surfaces of load lock chambers.

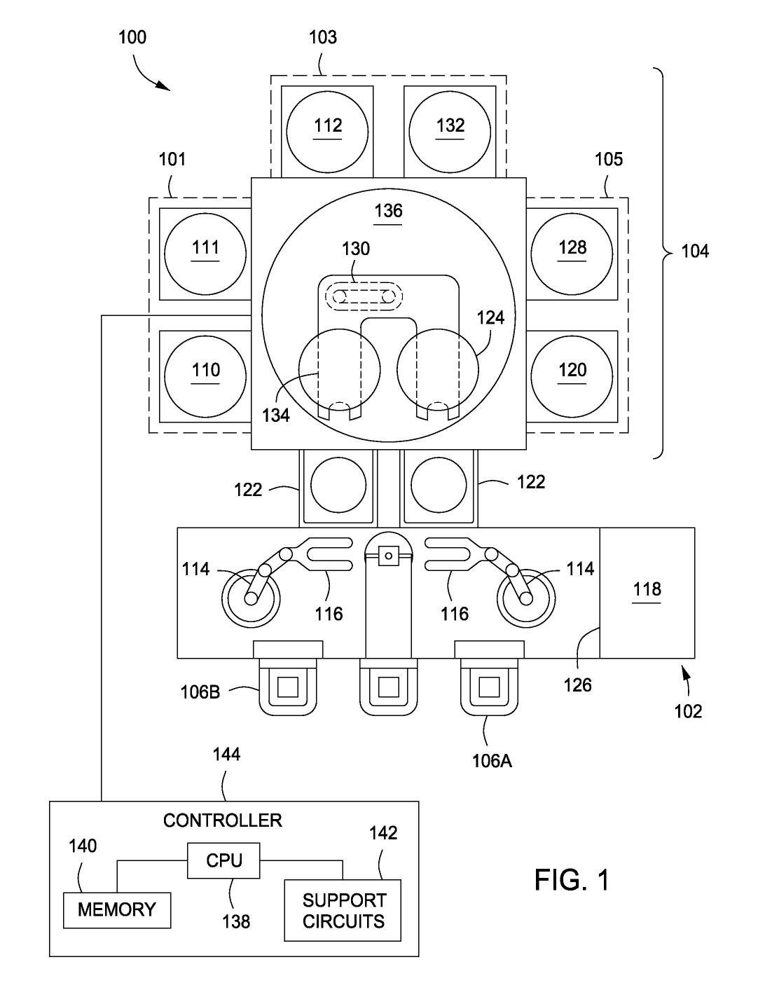

Referring to FIG. 1, in some embodiments, a substrate processing system 100 may generally comprise a vacuum-tight processing platform 104, a factory interface 102, and a system controller 144. Examples of processing systems that may be suitably modified in accordance with the teachings provided herein include the CENTURA® integrated processing system, one of the PRODUCER° line of processing systems (such as the PRODUCER® GT™), ADVANTEDGE™ processing systems, or other suitable processing systems commercially available from Applied Materials, Inc., located in Santa Clara, Calif. It is contemplated that other processing systems (including those from other manufacturers) may be adapted to benefit from the invention.

The platform 104 may include a plurality of process chambers (six shown) 110, 111, 112, 132, 128, 120 and at least one load-lock chamber (two shown) 122 that are coupled to a vacuum substrate transfer chamber 136. The factory interface 102 is coupled to the transfer chamber 136 via the load lock chambers 122. In some embodiments, for example, as depicted in FIG. 1, the process chambers 110, 111, 112, 132, 128, 120 may be grouped in pairs with each of the process chambers 110, 111, 112, 132, 128, 120 in each pair positioned adjacent to one another. In such embodiments, the process chambers may be configured such that processing resources 101, 103, 105 (i.e., process gas supply, power supply, or the like) may be shared between each of the process chambers 110, 111, 112, 132, 128, 120 within that pair. Although disclosed herein with reference to a twin chamber processing system, other multiple chamber processing systems (e.g., two or more) having shared resources may be modified and operated in accordance with the teachings provided herein. An example of a twin chamber processing system is described in U.S. Provisional Patent Application Ser. No. 61/330,156, filed Apr. 30, 2010, by Ming Xu, and entitled, “Twin Chamber Processing System,” which is hereby incorporated herein by reference in its entirety.

In some embodiments, the factory interface 102 comprises at least one docking station 108 and at least one factory interface robot (two shown) 114 to facilitate transfer of substrates. The docking station 108 is configured to accept one or more (two shown) front opening unified pods (FOUPs) 106A-B. In some embodiments, the factory interface robot 114 generally comprises a blade 116 disposed on one end of the robot 114 configured to transfer the substrate from the factory interface 102 to the processing platform 104 for processing through the load lock chambers 122. Optionally, one or more metrology stations 118 may be connected to a terminal 126 of the factory interface 102 to facilitate measurement of the substrate from the FOUPs 106A-B.

In some embodiments, each of the load lock chambers 122 (described below) may comprise a first port coupled to the factory interface 102 and a second port coupled to the transfer chamber 136. The load lock chambers 122 may be coupled to a pressure control system (described below) which pumps down and vents the load lock chambers 122 to facilitate passing the substrate between the vacuum environment of the transfer chamber 136 and the substantially ambient (e.g., atmospheric) environment of the factory interface 102.

In some embodiments, the transfer chamber 136 has a vacuum robot 130 disposed therein. The vacuum robot 130 generally comprises a one or more transfer blades (two shown) 134 coupled to a movable arm 131. In some embodiments, for example where the process chambers 110, 111, 112, 132, 128, 120 are arranged in groups of two as depicted FIG. 1, the vacuum robot 130 may comprise a two parallel blades 134 configured such that the vacuum robot 130 may simultaneously transfer two substrates 124 from the load lock chambers 122 to the process chambers 110, 111, 112, 132, 128, 120.

The process chambers 110, 111, 112, 132, 128, 120 may be any type of process chamber utilized in substrate processing. For example, in some embodiments, at least one of the process chambers 110, 111, 112, 132, 128, 120 may be an etch chamber, deposition chamber, or the like. For example, in embodiments where at least one of the process chambers 110, 111, 112, 132, 128, 120 is an etch chamber, the at least one of the process chamber 110, 111, 112, 132, 128, 120 may be a Decoupled Plasma Source (DPS) chamber available from Applied Materials, Inc. The DPS etch chamber uses an inductive source to produce high-density plasma and comprises a source of radio-frequency (RF) power to bias the substrate. Alternatively, or in combination, in some embodiments, at least one of the process chambers 110, 111, 112, 132, 128, 120 may be one of a HART™, E-MAX®, DPS®, DPS II, PRODUCER E, or ENABLER® etch chamber also available from Applied Materials, Inc. Other etch chambers, including those from other manufacturers, may be utilized. In embodiments where the process chambers 110, 111, 112, 132, 128, 120 are etch chambers, for example, the process chambers 110, 111, 112, 132, 128, 120 may use a halogen-containing gas to etch a substrate (e.g., substrate 124) disposed therein.

The system controller 144 is coupled to the processing system 100. The system controller 144 may control the operation of the system 100 using a direct control of the process chambers 110, 111, 112, 132, 128, 120 of the system 100 or alternatively, by controlling the computers (or controllers) associated with the process chambers 110, 111, 112, 132, 128, 120 and the system 100. In operation, the system controller 144 enables data collection and feedback from the respective chambers and system controller 144 to optimize performance of the system 100.

The system controller 144 generally includes a central processing unit (CPU) 138, a memory 140, and support circuit 142. The CPU 138 may be one of any form of a general purpose computer processor that can be used in an industrial setting. The support circuits 142 are conventionally coupled to the CPU 138 and may comprise cache, clock circuits, input/output subsystems, power supplies, and the like. To facilitate control of the processing system 100, the system controller 144 may be one of any form of general-purpose computer processor that can be used in an industrial setting for controlling various chambers and sub-processors. The memory, or computer-readable medium, 140 of the CPU 138 may be one or more of readily available memory such as random access memory (RAM), read only memory (ROM), floppy disk, hard disk, or any other form of digital storage, local or remote. The support circuits 142 are coupled to the CPU 138 for supporting the processor in a conventional manner. These circuits include cache, power supplies, clock circuits, input/output circuitry and subsystems, and the like.

The inventive methods disclosed herein may generally be stored in the memory 140 as a software routine that, when executed by the CPU 138, causes the system controller 144 to perform processes of the present invention. The software routine may also be stored and/or executed by a second CPU (not shown) that is remotely located from the hardware being controlled by the CPU 138. Some or all of the method of the present invention may also be performed in hardware. As such, the invention may be implemented in software and executed using a computer system, in hardware as, e.g., an application specific integrated circuit or other type of hardware implementation, or as a combination of software and hardware. The software routine, when executed by the CPU 138, transforms the general purpose computer into a specific purpose computer (controller) 144 that controls the chamber operation such that the methods disclosed herein are performed.

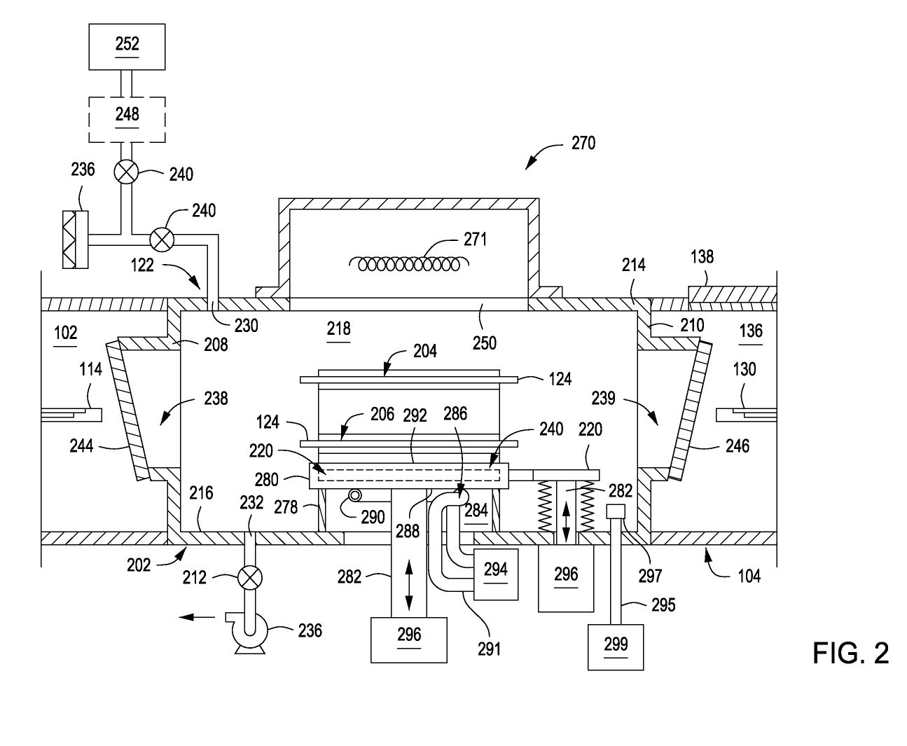

Referring to FIG. 2, in some embodiments, the load lock chamber 122 may generally comprise a chamber body 202, a first substrate holder 204, a second substrate holder 206, a temperature control pedestal 240 and a heater module 270 comprising one or more heating elements 271. The chamber body 202 may be fabricated from a singular body of material such as aluminum. The chamber body 202 includes a first side wall 208, a second side wall 210, lateral walls (not shown), a top 214 and a bottom 216 that define a chamber volume 218. In some embodiments, a gas distribution ring (not shown) is coupled to the top 214 to facilitate a radial delivery of gas to the chamber volume 218. An example of a suitable gas distribution ring is described in U.S. Provisional Patent Application Ser. No. 61/330,041, filed Apr. 30, 2010, by Jared Ahmad Lee, et al., and entitled, “APPARATUS FOR RADIAL DELIVERY OF GAS TO A CHAMBER AND METHODS OF USE THEREOF,” which is hereby incorporated herein by reference in its entirety.

A window 250 is disposed in the top 214 of the chamber body 202 and is at least partially covered by the heater module 270. In some embodiments, the window 250 is at least partially optically transparent to facilitate the transfer of heat from the heating elements 271 to the chamber volume 218. The window 250 may comprise any at least partially optically transparent material, such as a glass, crystalline material, or the like. In some embodiments, the window 250 comprises a silicon based material, for example, quartz (SiO₂).

The pressure of the chamber volume 218 may be controlled so that the load lock chamber 122 may be evacuated to substantially match the environment of the transfer chamber 136 and be vented to substantially match the environment of the factory interface 102. The chamber body 202 includes one or more vent passages (two shown) 230, 295 and a pump passage 232. In some embodiments, a first vent passage 230 and the pump passage 232 are positioned at opposite ends of the chamber body 202 to induce laminar flow within the chamber volume 218 during venting and evacuation to minimize particulate contamination. In some embodiments, the vent passage 230 is coupled to a high efficiency air filter 236 such as available from Camfil Farr, Inc., of Riverdale, N.J.

The vent passage 230 may be additionally coupled to a first gas source 252, described below, through one or more valves 240 to provide a gas mixture into the chamber volume 218. In such embodiments, the vent passage 230 may be a process gas line to provide a gas mixture to the load lock chamber 122 to perform a process on a substrate disposed therein, such as an abatement process. In some embodiments, the vent passage 230 may be coupled to the gas distribution ring (described above) wherein the gas mixture may be distributed through an array of holes to optimize flow uniformity. In such embodiments, the gas distribution ring may be fabricated by a material transmissive to the heat generated from the heater module 270 such as not to substantially interfere with the heating of the substrates positioned on the substrate holders 204, 206. The first gas source 252 may supply any gas or gas mixture suitable for performing a process, purge, or the like. For example, in some embodiments, the gas source 252 may supply at least one of nitrogen (N₂), argon (Ar), hydrogen (H₂), alkanes, alkenes, helium (He), oxygen (O₂), ozone (O₃), water vapor (H₂O), and the like.

In one embodiment, a remote plasma source (RPS) 248 may be alternatively coupled to the vent passage 230 to assist in removing residues from the substrate surfaces. The remote plasma source 248 provides plasma formed from the gas mixture provided by the first gas source 252 to the load lock chamber 122. In embodiment the remote plasma source (RPS) 248 is present, a diffuser (not shown) may be disposed at the outlet of the vent passage 230 to facilitate delivery the generated plasma into the load lock chamber 122.

The pump passage 232 is coupled to a point-of-use pump 236, such as available from Alcatel, headquartered in Paris, France, via a valve 212. The point-of-use pump 236 has low vibration generation to minimize the disturbance of the substrate 124 positioned on the holders 204, 206 within the load lock chamber 122 while promoting pump-down efficiency and time by minimizing the fluid path between the load lock chamber 122 and pump 236 to generally less than three feet.

The vent passage 295 may be coupled to a second gas source 299, (described below), to provide a gas mixture into the chamber volume 218. In some embodiments, a diffuser 297 may be coupled to the vent passage 295 to facilitate distribution of the gas from the second gas source 299 into the chamber volume 218. In some embodiments, the second gas source 299 may supply any gas or gas mixture suitable for purging the chamber volume 218. In some embodiments, the second gas source 299 may supply an inert gas, for example, such as nitrogen, argon, xenon, helium, or the like. In some embodiments, the vent passage 295 may be a dedicated purge line, dedicated to providing one or more inert gases to the load lock chamber 122. In operation, for example, the second gas source 299 may provide a flow of inert gas to the chamber volume 218 during various stages of a substrate process, for example, during at least one of transferring a substrate 124 into and out of the load lock chamber 122, pumping down the load lock chamber 122, or performing a process within the load lock chamber 122.

A first loading port 238 is disposed in the first wall 208 of the chamber body 202 to allow the substrate 124 to be transferred between the load lock chamber 122 and the factory interface 102. A first slit valve 244 selectively seals the first loading port 238 to isolate the load lock chamber 122 from the factory interface 102. A second loading port 239 is disposed in the second wall 210 of the chamber body 202 to allow the substrate 124 to be transferred between the load lock chamber 122 and the transfer chamber 136. A second slit valve 246 which is substantially similar to the first slit valve 244 selectively seals the second loading port 239 to isolate the load lock chamber 122 from the vacuum environment of the transfer chamber 136.

The first substrate holder 204 is concentrically coupled to (i.e., stacked on top of) the second substrate holder 206 that is disposed above the chamber bottom 216. The substrate holders 204, 206 are generally mounted to a hoop 220 that is coupled to a shaft 282 that extends through the bottom 216 of the chamber body 202. Typically, each substrate holder 204, 206 is configured to retain one substrate. The shaft 282 is coupled to a lift mechanism 296 disposed exterior to the load lock chamber 122 that controls the elevation of the substrate holders 204 and 206 within the chamber body 202. A bellows 284 is coupled between the hoop 220 and the bottom 216 of the chamber body 202 and disposed around the shaft 282 to provide a flexible seal between the second substrate holder 206 and the bottom 216, thus preventing leakage from or into the chamber body 202 and facilitating raising and lowing of the substrate holders 204, 206 without compromising the pressure within the load lock chamber 122.

The first substrate holder 204 is utilized to hold an unprocessed substrate from the factory interface 102 while the second substrate holder 206 is utilized to hold a processed substrate (e.g., an etched substrate) returning from the transfer chamber 136. The flow within the load lock chamber 122 during venting and evacuation is substantially laminar due to the position of the vent passage 230 and pump passage 232 and is configured to minimize particulate contamination.

The temperature control pedestal 240 is coupled to the bottom 216 of the chamber body 202 by a support 278. The support 278 may be hollow or include passages therethrough to allow fluids, electrical signals, sensor and the like to be coupled to the pedestal 240. The temperature control pedestal 240 generally includes a platen 280 which is generally fabricated from a thermally conductive material, for example, such as aluminum or stainless steel, but may alternatively be comprised of other materials, such as ceramic. The platen 280 generally has a heat transfer element 286. The heater transfer element 286 may be a fluid passage disposed in the platen 280 or disposed in contact with a lower surface 288 of the platen 280. Alternatively, the heat transfer element 286 may be a circulated water jacket, a thermoelectric device, such as a Peltier device, or other structure that may be utilized to control the temperature of the platen 280.

In some embodiments, the heat transfer element 286 comprises a tube 290 disposed in contact with the lower surface 288 of the platen 280. The tube 290 is coupled to a fluid source 294 that circulates a fluid through the tube 290. The fluid, for example, facility water from the fluid source 294, may optionally be thermally regulated. The tube 290 may be disposed in a substantially circular or spiral pattern against the lower surface 288 of the platen 280. Typically, the tube 290 is brazed to or clamped against the lower surface 288 or adhered using a conductive adhesive. Optionally, a conductive plate (not shown), such as a copper plate may alternatively be disposed between the tube 290 and platen 280 to promote uniformity of heat transfer across the width of the platen 280.

The hoop 220 having the substrate holders 204, 206 coupled thereto may be lowered to a first position where an upper surface 292 of the platen 280 is in close proximity or in contact with the substrate supported by the second substrate holder 206. In the first position, the platen 280 may be used to regulate the temperature of the substrate disposed on (or proximate to) the platen 280. For example, a substrate returning from processing may be cooled in the load lock chamber 122 by supporting the substrate during the evacuation of the load lock chamber 122 on the upper surface 292 of the platen 280. Thermal energy is transferred from the substrate through the platen 280 to the heat transfer element 286, thereby cooling the substrate. After cooling the substrate, the substrate holders 204, 206 may be raised towards the top 214 of the chamber body 202 to allow the robots 130, 114 to access to the substrate seated in the second substrate support 206. Optionally, the holders 204, 206 may be lowered to a position where the upper surface 292 is in contact or close proximity to the substrate supported by the first substrate holder 204. In this position, the platen 280 may be used to thermally regulate and heat the substrate.

In some embodiments, in operation, the load lock chamber 122 facilitates the transfer of substrates between the ambient atmosphere of the factory interface 102 and the vacuum atmosphere of the transfer chamber 136. The load lock chamber 122 temporarily houses the substrate while the atmosphere within the load lock chamber 122 is adjusted to match the atmosphere of the transfer chamber 136 or factory interface 102 into which the substrate is to be transferred. For example, the first slit valve 244 is opened while the load lock chamber 122 is vented to substantially atmospheric pressure to match the atmosphere of the factory interface 102. The factory interface robot 120 transfers an unprocessed substrate from one of the FOUPs 106A-B to the first substrate holder 204. The substrate subsequently transfers to the process chambers 110, 111, 112, 132, 128, 120 to perform an etch process. After the etch process is completed, the pump passage 232 in the load lock chamber 122 is subsequently opened and the load lock chamber 122 is pumped down to the pressure substantially equal to the pressure of the transfer chamber 136. Once the pressures within the load lock 122 and transfer chamber 136 are substantially equal, the second slit valve 246 is opened. The processed substrate is transferred to position on the second substrate holder 206 by the transfer robot 130 in the load lock chamber 122. The second slit valve 246 is closed once the blade of the transfer robot 130 is removed.

In some embodiments, for example where an etch process is performed, an abatement process may be performed on the substrate 124 in the load lock chamber 122. The abatement process is performed to remove particulates, for example polymeric or carbon based particulates from the substrate 124 and/or residual reactant gases that may adsorb onto the surface of the substrate 124 while processing. In such embodiments, during the abatement process, the second substrate holder 206 may be raised the processed substrate 124 toward the heater module 270 to increase heating efficiency, thereby converting the residues to non-volatile compounds that may be pumped out of the load lock chamber 122. During the abatement process, one or more gases may be provided to the load lock chamber to facilitate removal of process residues from the substrate. For example, in some embodiments, the first gas source 252 may provide a process gas comprising ozone (O₃) to facilitate partially convert particulates disposed on the substrate 124 into a gaseous state to facilitate removal of the particulates via a purge. Alternatively, or in combination, an inert gas may be supplied into the load lock chamber 122 via the first and or second gas source 252, 299 to promote removal of the residues or particulates from the load lock chamber 122. After the residues have been partially or totally outgassed from the substrate surface, a purge of inert gas supplied by one or both of the gas sources 252, 299 is performed to facilitate removal of the residues or particulates from the load lock chamber 122.

Following the removal of the residues or particulates from the load lock chamber 122 one or both of the vent passages 230, 295 may be opened to allow the pressure in the load lock chamber 122 to substantially match the pressure in the factory interface 102, thereby facilitating the processed substrate being transferred to the FOUPs 106A-B. While venting, the pedestal 240 is raised to contact the processed substrate rest on the second substrate holder 206. The processed substrate is thus cooled by transferring heat through the pedestal 240 to the fluid circulating in the tube 290. Once the pressures are matched, the first slit valve 244 is opened to allow the factory interface robot 114 to access the load lock chamber 122 to remove the processed substrate from the second substrate holder 206 and return to one of the FOUPs 106A-B. As such, as the substrate cooling process and the load lock chamber venting process is performed simultaneously, the overall process period and cycle time is reduced and productivity and throughput is increased. A newly unprocessed substrate from the FOUPs 106A-B may be transferred into the load lock chamber 122 on the first substrate holder 204 as the processed substrate removed from the second substrate holder 206 by the factory interface robot 114 while the slit valve 244 the load lock chamber 122 remains opened.

After completion of the substrate transfer, the first slit valve 244 and vent passage 230 are closed. The pump passage 232 is subsequently opened and the load lock chamber 122 is pumped down to the pressure substantially equal to the pressure of the transfer chamber 136. Once the pressure of the load lock chamber 122 and the transfer chamber 136 are substantially equal, the second slit valve 246 is opened and the transfer robot 130 then retrieves the newly unprocessed substrate for position in the first substrate holder 204 for processing in one or more of the process chambers 110, 112, 132, 128, 120 circumscribing the transfer chamber 136 to repeatedly and consecutively perform the etch process and abatement process as stated above. After substrate transfer is completed, the second slit valve 246 is closed to seal the load lock chamber 122 from the transfer chamber 136 as stated above.

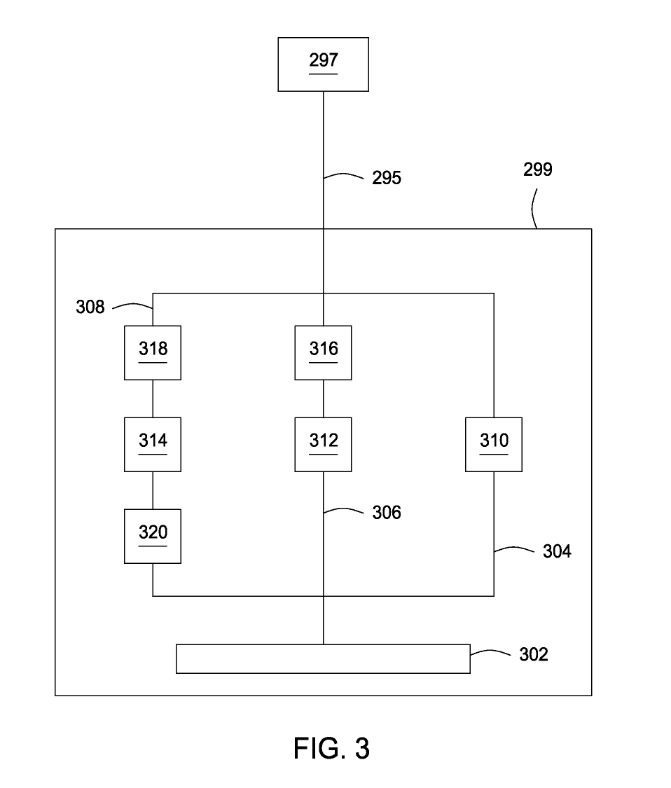

Referring to FIG. 3, in some embodiments, the second gas source 299 may generally comprise a gas supply 302, a fast vent passage 304, a slow vent passage 306 and purge passage 308. The gas supply 302 may comprise one or more gas sources (not shown) coupled to one or more mass flow controllers (not shown) to provide a mixture of gases to the load lock chamber 122 via the fast vent passage 304, slow vent passage 306 and purge passage 308. In some embodiments, each of the fast vent passage 304, slow vent passage 306 and purge passage 308 may comprise a respective valve (e.g., fast vent valve 310, slow vent valve 312, and purge valve 314) to independently control the flow of gas therethrough. The fast vent valve 310, slow vent valve 312, and purge valve 314 may be any type of valve for example, a switching valve, high speed valve, stop valve, or the like, to facilitate control of the flow of gas. Other valve configurations using greater or fewer valves may be utilized to control the flow of the gas from the second gas source 299 to the chamber load lock chamber 122.

In some embodiments, the slow vent passage 306 and purge passage 308 may each comprise one or more (two shown) flow restrictors 316, 318 disposed before or after the slow vent valve 312 and purge valve 314, respectively. When present, the flow restrictors 316, 318 slow the flow rate of gas provided by the gas supply through the slow vent passage 306 and purge passage 308. In addition, the flow restrictors 316, 318 may reduce variations in pressure within the slow vent passage 306 and purge passage 308 when the flow of gas is started or stopped using the slow vent valve 312 and purge valve 314, thereby delivering consistent quantities of the gases provided by the gas supply 302. In some embodiments, the purge passage 308 may comprise a mass flow controller 320 to control the flow rate of gas through the purge passage 308.

In operation, for example, each of the fast vent passage 304, slow vent passage 306 and purge passage 308 may be independently controlled via the fast vent valve 310, slow vent valve 312, and purge valve 314 to provide a flow of gas at various flow rates. For example, in some embodiments, the slow vent valve 312 may first be opened to provide gas from the gas supply 302 to the load lock chamber 122 at a first flow rate via the slow vent passage 306. After a predetermined amount of time or when a predetermined amount of pressure is reached within the load lock chamber 122, the fast vent valve 310 may be opened to provide the gas at a second, higher flow rate. The purge valve 314 may be opened to provide the gas to the chamber (e.g., the load lock chamber 122) via the purge passage 308 to purge the chamber. Other modes of operation may be used to provide the gas to the load lock chamber 122 at a desired flow rate, including the use of variable position valves, flow meters, or the like, to control the flow rate of the gas.

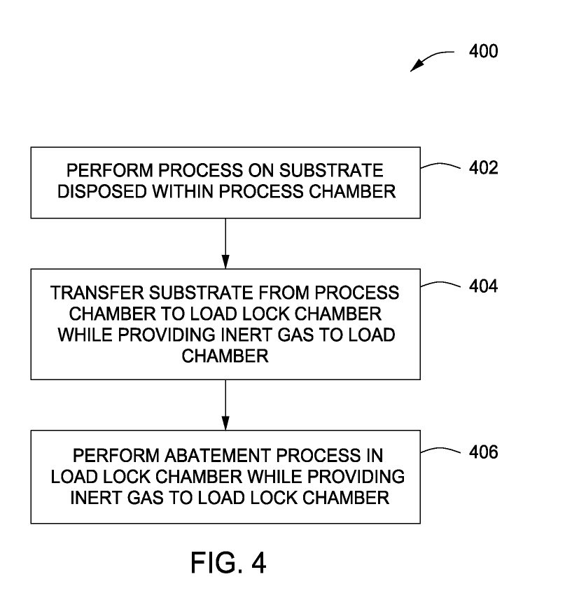

FIG. 4 depicts a method 400 for removing process byproducts from a load lock chamber in accordance with some embodiments of the present invention. The method 400 may be performed in any type of load lock chamber, for example, load lock chamber 122 described above.

The method begins at 402, where a process is performed on a substrate disposed within a process chamber. The process may be any process performed on a substrate, for example, an etch, deposition, anneal, or the like. The substrate may be any substrate, such as a silicon substrate, for example crystalline silicon (e.g., Si<100> or Si<111>), silicon oxide, strained silicon, doped or undoped polysilicon, or the like, a III-V compound substrate, a silicon germanium (SiGe) substrate, an epi-substrate, a silicon-on-insulator (SOI) substrate, a display substrate such as a liquid crystal display (LCD), a plasma display, an electro luminescence (EL) lamp display, a solar array, solar panel, a light emitting diode (LED) substrate, a semiconductor wafer, or the like. The process chamber may be any type of process chamber suitable for substrate processing, for example, such as one or more of the process chambers described above with respect to FIG. 1 (e.g., process chambers 110, 111, 112, 132, 128, 120). In addition, the process chamber may be coupled to a processing system, for example, the processing system 100 described above.

Next, at 404, the substrate is transferred from the process chamber to the load lock chamber while providing an inert gas to the load lock chamber. A flow of inert gas to the load lock chamber during the substrate transfer ensures that contaminating gases or process byproducts produced due to substrate processing are not trapped in the gas lines and the load lock chamber.

The load lock chamber may be any type of load lock chamber suitable to transfer substrates to and from a processing system. For example, in some embodiments, the load lock chamber is similar to the load lock chamber 122 described above in FIGS. 1 and 2. Referring back to FIG. 2, in such embodiments, the load lock chamber 122 may be evacuated, or pumped down, to a pressure substantially equal to that of transfer chamber 136. Once the pressures within the load lock 122 and transfer chamber 136 are substantially equal, the second slit valve 246 is opened. In some embodiments, a flow of inert gas is provided via the vent passages 230, 295 before, or in some embodiments, simultaneously with the opening of the second slit valve 246 and continues to flow while the processed substrate is transferred. In some embodiments, the flow of inert gas may be coordinated with respect to the vacuum pump such that the pressure in the load lock chamber 122 is maintained substantially equal to that of the transfer chamber 136. In such embodiments, for example, the pressure may be maintained via the valve 212 in the pump passage 232. For example, the valve 212 may be a needle valve configured to regulate the flow of gas through the pump passage 232 to facilitate maintaining a desired pressure within the chamber volume 218. Alternatively, or in combination, in some embodiments, the valve 212 may be fully open and the flow of inert gas adjusted to maintain a low pressure within the chamber volume 218. The processed substrate is them transferred to position on the second substrate holder 206 by the transfer robot 130 in the load lock chamber 122. The second slit valve 246 is closed once the blade of the transfer robot 130 is removed.

Referring back to FIG. 4, the inert gas may be any inert gas, for example, nitrogen (N), argon (Ar), xenon (Xe), helium (He), or the like, and may be provided at any flow rate sufficient to prevent process byproducts from entering and/or condensing in with gas lines of the load lock chamber 122. For example in some embodiments, the inert gas may be provided at a flow rate of about 100 sccm to about 50000 sccm. The process byproducts may be any byproducts produced as a result of any process performed in the process chamber. For example, in some embodiments, the process byproducts may comprise bromine, fluorine, chlorine, halogens, carbon containing products, such as carbon containing polymers or oxides, such as silicon oxide, metal oxides, moisture (e.g., water), or the like.

Next, at 406, an abatement process may be performed in the load lock chamber while providing an inert gas. The abatement process may be any abatement process suitable to facilitate the removal of particulates, for example polymeric or carbon based particulates from the substrate 124 and/or residual reactant gases that may adsorb onto the surface of the substrate 124 while processing. For example, the abatement process may be similar to the abatement process performed in the load lock chamber 122 described above with respect to FIG. 2.

The inert gas may be any inert gas, for example, nitrogen, argon, xenon, helium, or the like. The inert gas may be provided at any flow rate to facilitate the removal of residual reactant gases and/or process byproducts from the load lock chamber. For example, in some embodiments, the inert gas may be provided at a flow rate of about 100 sccm to about 50,000 sccm. In some embodiments, after an initial flow of inert gas, the flow rate the may be increased to facilitate further removal of the residual reactant gases and/or process byproducts from the load lock chamber.

For example, in some embodiments, the inert gas may first be provided at a first flow rate for a first period of time. The first flow rate may be any flow rate suitable to facilitate the removal of process byproducts from the substrate surfaces while not causing the process byproducts to uncontrollably disperse throughout the load lock chamber. For example, in some embodiments, the flow rate may be about 100 sccm to about 50,000 sccm. Referring to FIG. 2, in some embodiments, for example where the first gas source 252 provides a process gas, such as ozone (O₃), to facilitate the abatement process, the inert gas may be provided by the second gas source 299 via the purge passage 308 (described above in FIG. 3). Alternatively, or in combination, in some embodiments the inert gas may be provided by the first and second gas source 252, 299.

In some embodiments, the inert gas may be provided by the second gas source 299 at the first flow rate via a first vent passage, for example, such as the slow vent passage 306 described above with respect to FIG. 3. The first period of time may be any amount of time required to facilitate the removal of process byproducts. In some embodiments, the first period of time may be a predetermined amount of time, for example, such as about 5 to about 120 seconds. Alternatively, in some embodiments, the first period of time may be any amount of time required to reach a first pressure within the load lock chamber. For example, in some embodiments, the inert gas may be provided at the first flow rate until a pressure of about 10 mTorr to about 400 Torr is reached within the load lock chamber. After the first period of time the inert gas may be provided at a second flow rate for a second period of time, wherein the second flow rate is higher than the first flow rate. The second, higher flow rate may further facilitate removal of process byproducts from the substrate surfaces. The second flow rate may be any flow rate, for example, in some embodiments, the second flow rate may be about 100 to about 50,000 sccm. In some embodiments, the flow rate of the inert gas may be gradually increased from the first flow rate to the second flow rate, for example the flow rate may be increased from the first flow rate to the second flow rate over a period of time of about 1 to about 10 seconds. The gradual increase of the flow rate may provide a consistent or even increase of pressure within the load lock chamber, thereby facilitating the removal of the process byproducts while preventing the process byproducts from dispersing throughout the load lock chamber.

In some embodiments, the inert gas may be provided at the second flow rate by increasing the flow rate through the same vent passage utilized to provide the first flow rate. Alternatively, in some embodiments, a second vent passage, for example, such as the fast vent passage 304 described above with respect to FIG. 3 may be utilized to provide the inert gas at the second flow rate. The second period of time may be any amount of time required to facilitate the removal of process byproducts. In some embodiments, the second period of time may be a predetermined amount of time, for example, such as about 1 to about 20 seconds. Alternatively, in some embodiments, the second period of time may be any amount of time required to reach a first pressure within the load lock chamber. For example, in some embodiments, the inert gas may be provided at the second flow rate until a pressure of about 20 mTorr to about 400 Torr is reached within the load lock chamber.

Referring back to FIG. 4, after the abatement process is performed at 406, the method generally ends and the substrate may be removed from the processing system or proceed for further processing and/or fabrication. In some embodiments, the substrate may be transferred to a factory interface, for example such as factory interface 102 described above and removed from the processing system via a front opening unified pod, for example, such as the FOUP 106A, 106B described above. In some embodiments, the substrate may be transferred back into a process chamber within the same, or in some embodiments, a different processing system to perform subsequent substrate processing steps.

Thus, methods for removing process byproducts from a load lock chamber are disclosed herein. The inventive method advantageously prevents corrosion and contamination of substrate processing systems by preventing process byproducts from condensing within gas lines and upon surfaces of load lock chambers.

While the foregoing is directed to embodiments of the present invention, other and further embodiments of the invention may be devised without departing from the basic scope thereof.

1. A method for removing process byproducts from a load lock chamber, comprising:
performing a process on a substrate disposed within a process chamber;
transferring the substrate from the process chamber to a load lock chamber; and
providing an inert gas to the load lock chamber via at least one gas line while transferring the substrate from the process chamber to the load lock chamber.

2. The method of claim 1, wherein the process byproducts comprise at least one of bromine, fluorine, chlorine, halogens, carbon containing polymers, oxides, silicon oxide, metal oxides, or water.

3. The method of claim 1, further comprising:
transferring the substrate from the load lock chamber to a transfer chamber; and
providing the inert gas to the load lock chamber via the at least one gas line while transferring the substrate from the load lock chamber to the transfer chamber.

4. The method of claim 1, wherein the inert gas is provided at a flow rate of about 100 to about 50,000 sccm.

5. The method of claim 1, further comprising:
performing an abatement process on the substrate in the load lock chamber; and
providing the inert gas to the load lock chamber via the at least one gas line while performing the abatement process on the substrate.

6. The method of claim 5, wherein providing the inert gas to the load lock chamber via the at least one gas line comprises providing the inert gas via at least one of a first gas line disposed proximate a top portion of the load lock chamber and a second gas line disposed proximate a bottom portion of the load lock chamber.

7. The method of claim 5, further comprising:
exposing the substrate to a process gas comprising ozone (O₃) while performing the abatement process, wherein the process gas is providing via a first gas line disposed proximate a top portion of the load lock chamber and wherein the inert gas is provided via at least one gas line including a second gas line disposed proximate a bottom portion of the load lock chamber.

8. The method of claim 5, wherein providing the inert gas to the load lock chamber further comprises:
providing the inert gas at a first flow rate for a first period of time; and
subsequent to the first period of time, providing the inert gas at a second flow rate for a second period of time, wherein the second flow rate is higher than the first flow rate.

9. The method of claim 8, wherein the inert gas is provided at the first flow rate via a first vent line, and wherein the inert gas is provided at the second flow rate via a second vent line.

10. The method of claim 8, wherein providing the inert gas at the first flow rate comprises:
increasing a flow rate of the inert gas until the first flow rate is reached, wherein the flow rate is increased over a time period of about 1 to about 60 seconds.

11. The method of claim 8, wherein the first flow rate is about 10 to about 50,000 sccm.

12. The method of claim 8, wherein providing the inert gas at the first flow rate for the first period of time comprises providing the inert gas at the first flow rate until a first chamber pressure is reached.

13. The method of claim 12, wherein the first chamber pressure is about 10 mTorr to about 400 Torr.

14. The method of claim 8, wherein the first period of time is about 1 to about 120 seconds.

15. The method of claim 8, wherein the second flow rate is about 100 to about 50,000 sccm.

16. The method of claim 8, wherein the second period of time is about 1 to about 120 seconds.

17. The method of claim 1, wherein the inert gas comprises at least one of nitrogen, argon, xenon or helium.

18. A method for removing process byproducts from a load lock chamber, comprising:
performing a process on a substrate disposed within a process chamber;
transferring the substrate from the process chamber to a load lock chamber; and
providing an inert gas to the load lock chamber via a dedicated purge gas line while transferring the substrate from the process chamber to the load lock chamber.

19. The method of claim 18, further comprising:
performing an abatement process on the substrate within the load lock chamber; and
providing the inert gas to the load lock chamber via the dedicated purge gas line while performing the abatement process on the substrate.

20. The method of claim 19, further comprising:
providing ozone to the load lock chamber during the abatement process via a first gas line while providing the inert gas via the dedicated purge gas line
